(19) United States
(12) Patent Application Publication
(10) Pub. No.: US 2022/0117279 A1
(43) Pub. Date: Apr. 21, 2022

(54) CLEAR PLANT EXTRACT EMULSION AND METHOD FOR PREPARATION

(71) Applicant: Sorse Technology Corporation, Seattle, WA (US)

(72) Inventors: Rodger Scott Riefler, Monroe, WA (US); Michael S. Flemmens, Chicago, IL (US); Daniel Sondheim, Seattle, WA (US); Jerry Bryan, Seattle, WA (US); Hali Hafeman, Seattle, WA (US)

(21) Appl. No.: 17/507,130

(22) Filed: Oct. 21, 2021

Related U.S. Application Data
(60) Provisional application No. 63/094,890, filed on Oct. 21, 2020.

(51) Int. Cl. A23L 29/10; A23L 2/60; A23L 2/385; A23L 29/00; A23L 2/70

(52) U.S. Cl. CPC A23L 29/10; A23L 2/60; A23L 29/035; A23L 29/05; A23L 2/70; A23L 2/385

(57) ABSTRACT

A method for preparing a clear plant extract emulsion is provided. Sugar is mixed with water. A bitter blocker is added to the mixed sugar and water to form an aqueous phase. The aqueous phase is combined with an oil phase including a plant extract and sucrose ester. The combined aqueous phase and oil phase are mixed under heat. A two-part homogenization of the combined aqueous and oil phases is performed resulting in a clear emulsion concentrate with a low turbidity.

### CROSS-REFERENCE TO RELATED APPLICATION

This non-provisional patent application claims priority under 35 U.S.C. § 119(e) to U.S. Provisional Patent application, Ser. No. 63/094,890, filed Oct. 21, 2020, the disclosure of which is incorporated by reference.

### FIELD

This application relates in general to emulsions, and in particular to a method for preparing clear plant extract emulsions.

### BACKGROUND

Some beverages, such as sparkling water, a few types of beers, and flavored beverages, are typically sold in clear form. If such beverage appears cloudy, a consumer may believe the beverage to be contaminated or bad.

Additionally, in some beverages sediment of the beverage can settle at the bottom of a bottle as time passes and are considered to be unstable. Unstable emulsions are also prone to creaming, coalescence, Oswald ripening, and flocculation. Accordingly, optical clarity of beverages, along with consistent flavor, stability, and extended shelf life are desirable and sought-after characteristics.

Existing beverages may become cloudy as time passes or have sediment that settles to the bottom of the bottle, both features which can be unsettling or off-putting to consumers even though the beverage may be safe to drink. Such features can be more frequent in beverages that include a mixture of ingredients that are immiscible since the ingredients are more likely to separate. For example, adding a plant extract for flavor, health, or medicinal purposes to a water based beverage can be difficult due to the form of the plant extract, such as an oil form.

Accordingly, what is needed is a method and emulsion for generating and maintaining the clarity of a beverage that is stable and has a long shelf life. Preferably, the emulsion includes a plant extract and is added to a beverage.

### SUMMARY

A method for preparing clear plant extract emulsions is provided. Sugar is mixed with water. A bitter blocker is added to the mixed sugar and water to form an aqueous phase. The aqueous phase is combined with an oil phase including a plant extract and sucrose ester. The combined aqueous phase and oil phase are mixed under heat. A two-part homogenization of the combined aqueous and oil phases is performed resulting in a clear emulsion concentrate with a low turbidity.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a flow diagram showing a method for preparing clear plant extract emulsions, in accordance with one embodiment.

### DETAILED DESCRIPTION

Beverages should be tasty, as well as visually pleasing, to a consumer to maintain and increase sales. Many beverages, including those that include immiscible ingredients, have a tendency to become cloudy or separate over time, which can be undesirable to consumers. Ensuring the clarity of a beverage with immiscible ingredients over long periods of time can be performed by adding an emulsion concentrate with a low molecular weight emulsifier to an aqueous base beverage.

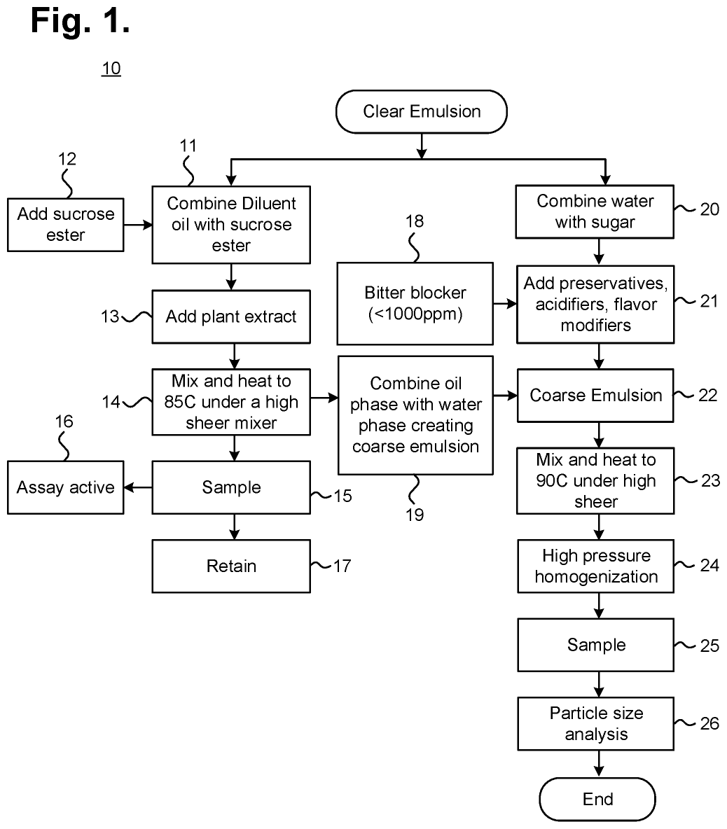

Plant extract to be added to a beverage can be emulsified with an aqueous phase and subsequently added to a base beverage. FIG. 1 is a flow diagram showing a method 10 for preparing clear plant extract emulsions, in accordance with one embodiment. The clear plant extract emulsion can be a concentrate that is subsequently added to a consumer product, such as a beverage, food, medical or cosmetic products, as a final resulting emulsion. The emulsion concentrate can be formed by combining (step 11) a diluent oil with an emulsifier (step 12) as an oil phase. The diluent oil can include a medium chain triglyceride with fatty acid chains having 8-10 carbon atoms and can be derived from coconut, palm oil, or glycerol, as well as from a combination of coconut, palm oil, or glycerol. However, other types of diluent oil are possible. In one embodiment, the diluent oil can be a triglyceride having a mixture of fatty acids with 50-98% caprylic acid (C8) and 1-35% capric acid (C10). In a further embodiment, the diluent oil should be in a liquid form at 20 degrees Celsius.

The emulsifier can include a non-ionic emulsifier with a hydrophilic-lipophilic balance greater than 8 and in one embodiment, can have a hydrophilic-lipophilic balance around 18. However, other values are possible. In one embodiment, the emulsifier can be sucrose ester. When the emulsifier is a sucrose ester, palmitic acid, used to make the sucrose ester, should be greater than or equal to 90% of the sucrose ester. However, the palmitic acid can also be within the range of 70% to more than 90%. Other emulsifiers are possible; however, at a minimum, the emulsifier should have a low molecular weight that absorbs onto the surface of the plant extract in oil form along with any carrier oil, if used, and bonds with the water. The emulsifier can lower the surface tension of the emulsion, which helps achieve smaller particle size and should have a molecular weight less than 1000; however, the smaller the molecular weight, the less processing may be required for the emulsion concentration, such as fewer homogenization passes, which are described below. The use of high molecular weight emulsifiers, such as over 1000 molecular weight, may make obtaining a clear emulsion unachievable based on the high weight. The emulsifier can include a single emulsifier or a combination of emulsifiers, and can be used in a concentration as low as 0.35% up to 5% weight in the emulsion concentrate. An example of a further emulsifier is lechithin.

A plant extract can be added (step 13) to the diluent oil and emulsifier of the oil phase and can include a single plant component or different plant components. The plant from which the components are extracted can include lavender, mint such as spearmint peppermint, tea tree oil, eucalyptus, hops, vitamins, nutraceuticals, citrus, and cannabis, and can be in the form of oil, terpenes, dry components, or processed components. For example, cannabinoids, as well as other botanical extracts, such as oil derived from all arial parts, seeds, and flowers, can be extracted from a cannabis plant in the oil form and mixed with the diluent oil and sucrose ester. Also, CBD isolate, such as in a powder form or oil form can be used. Other types of plants and plant extracts are possible; however, at a minimum, the extract should be a solventless extract. Also, in one embodiment, a purity of the extract should be 60% or higher.

A sample of the oil phase can be collected (step 15) and an assay can be performed (step 16) on the sample to determine the purity of the plant extract. If the concentration of the plant extract is below a predetermined threshold, such as 70%, the plant extract can be refined by using a different diluent oil or the plant extract can be further processed. Otherwise, if the purity of the plant extract meets or exceeds the threshold, the oil phase can be combined with the water phase, as described in further detail below.

Stability tests can be run on the oil phase to determine whether a phospholipid should be added. In one embodiment, phospholipids are added to the oil phase to help solubilize the target lipid, which is the plant extract, and increase stability. For instance, when the tsi is higher, a greater amount of movement exists. Thus, lower tsi values are desirable with lower movement, especially over time. If added, the phospholipid can be mixed with glycerol or propylene glycol.

The oil phase can be mixed and heated (step 14) to a temperature of around 85 degrees Celsius using a high shear mixer. Simultaneously to, prior to, or subsequent to the formulation of the oil phase, an aqueous phase can be formulated by first combining (step 20) water with sugar. The sugar works well with the emulsifier, especially sucrose ester to keep the emulsion concentrate stable, as well as prevents the need for a weighting agent. In one embodiment, the sugar is optional. Examples of the sugar include a sugar alcohol, such as sorbitol, xylitol, mannitol, erythritol, or isomalt, as well as other types of sugar, such as dextrose, sucrose, or simple syrups. In a further embodiment, a decrystalization agent, such as glycerin or propylene glycol can be used to modify any crystal structures formed by the sugar.

A bitter blocker (step 18) or other ingredients, including preservatives, acidifiers, or flavor modifiers (step 21) can be added to the aqueous phase. Bitter blockers can help mask an undesirable flavor or bitterness of the plant extract used, while the flavor modifiers can introduce a particular flavor to the emulsion concentrate. The preservatives can include citric acid, sodium benzoate, potassium sorbate, ascorbic acid, or gluconic acid. Acidifiers can also be added, but are not necessary in the concentrated form of the emulsion. However, in one example, gluconic acid or D-gluconolactone can be added to impart a pleasant tartness for flavor. Also, when sodium benzoate is used as a preservative, an acidic pH is required for the sodium benzoate to be effective and thus, an acidifier can be helpful to lower the pH. The clear emulsion is typically prepared with a neutral pH in concentrated form around 5.98-7.5 but can be in the range of 3.2-9.8.

In one embodiment, no preservative is necessary if glycerol or sorbitol is added to the emulsion concentrate since both glycerol and sorbitol help lower water activity of the emulsion. In a further embodiment, if the water content or activity of the emulsion is below 0.6%, preservatives are not necessary. Accordingly, after the emulsion concentrate is formed, a test can be performed to determine the water activity, which is expressed on a scale of 0 to 1 with 1 representing pure water.

Surfactants can also be added to the aqueous phase to decrease surface tension of the aqueous phase. Examples of surfactants can include fatty acid esters of palmitic acid, tween, or polysorbate.

Above, the emulsifier was described as being added to the oil phase. However, the emulsifier can be added to the aqueous phase, rather than the oil phase, and dispersed with high shear.

Once the oil phase is mixed and heated (step 14) to a temperature around 85 degrees Celsius, as described above, the oil phase is combined with the aqueous phase (step 19) to form a coarse emulsion (step 22). The coarse emulsion is mixed under high shear and heated (step 23). In one embodiment, the coarse emulsion is heated to a temperature around 80-90 degrees Celsius; however, other temperatures are possible. The high shear can be around 10,000 RPM, but other speeds for the shear are possible.

Subsequently, the emulsion can be homogenized (step 24) to break down and reduce a size of the particles of plant extract suspended in the aqueous phase. In one embodiment, a two stage impactor can be used to perform the homogenization. A first stage can have a pressure of up to 500 psi, while a second stage has a pressure that can be at least 8000 psi; however, other values for the pressure during homogenization are possible. A single or multiple passes through the two stage impactor can be performed. In one example, the number of passes required to obtain a particular particle size can be dependent on the type of emulsifier used. For instance, when the emulsifier is sucrose ester, no more than 3 passes are likely needed to ensure a particle size that results in a low measure of turbidity or clearness of a beverage with the emulsion concentrate.

A test of the emulsion can be performed after one or more passes through the two stage impactor to confirm particle size by taking a sample (step 25) of the homogenized emulsion and performing a particle size analysis (step 26). Like concentration, the size of the particles and their distribution throughout a medium, such as a beverage, are equally important to stability, uniformity/homogeneity, and safety. Particle size also has a large impact on the clarity of the emulsion. Clarity is measured by turbidity, which measures how much light is scattered when directed at a sample. The units of turbidity are reported in nephelometric turbidity units (NTUs) or formazin nephelometric units (FTU). The closer an NTU or FTU value is to 0, the clearer the sample tested.

A clear sample can have an NTU value between 0 and 10; however, other ranges are possible, such as up to 20 or 30 NTU. In one embodiment, a desired particle size for ensuring a low turbidity is around 0.8-0.9 μm diameter with a span of 0.7-0.8 μm. However, other particle sizes can be used, including both larger and smaller particle sizes. When the particle sizes are within the desired range, the turbidity of the emulsion is around 1-2 NTU.

The clear emulsion concentrate can then be added to beverages, as well as other food, medical or cosmetic products. The total of the oil phase should have a weight of 0.1% to 30% of the total product, which includes the emulsion and the product into which the emulsion is combined. In one embodiment, the emulsion can be considered stable and clear when dosed into a beverage at a final concentration up to 5%. However, the final concentration of the oil phase can differ dependent on the target extract or compound used, such as a cannabinoids, terpene and flavor oils.

Stability is also an important feature of a good to be consumed or utilized. As particle size decreases, the surface area of the oil increases, typically leading to an increase in stability. Emulsions, by definition, are thermodynamically unstable and will eventually break. For simple emulsions, such as oil and vinegar, separation can occur within seconds. However, for well-formulated emulsions, the process of separation can be slowed to months and years. The low turbidity emulsion been specifically designed to provide exceptionally long-term uniformity, homogeneity, and stability over time.

The emulsion concentrate can include ingredients in the amounts described below. However, other ingredients and amounts can be used.

TABLE 1
Ingredients of Emulsion Concentrate

| | | Preferred | | |
|---|---|---|---|---|
| | | Percentage | Minimum | Maximum |
| Phase | Ingredient | Range | Percentage | Percentage |
| Water Phase | Liquid Sorbitol, D- | 58-65% | 0% | 90% |
| | Glucitol | | | |
| | Glycerin | 25-35% | 0% | 35% |
| Oil Phase | Plant Extract | 1-5% | 0.01% | 9% |
| | Bitter Blocker | 1-2% | 0.8% | 2% |
| | Carrier Oil | 2-4% | 0% | 10% |
| | Primary Emulsifier | 1-4% | 0.3% | 5% |
| | Secondary Emulsifier | 0.3-1% | 0.3% | 5% |

The liquid sorbitol can include a mixture of D-Glucitol as a sugar with water. In one embodiment, the mixture includes around 70% of the sugar and around 30% water. The glycerin can be used as a decrystalization agent to prevent crystallization of the sugar. The carrier oil can be added to the oil phase to reduce a viscosity of the plant extract, including the plant extract oil for increasing fluidity. An example of the carrier can include mid-chain triglycerides. One or more emulsifiers can be used in the oil phase and in one embodiment, the primary emulsifier can include sucrose ester, while the second emulsifier can include lecithin. However, other types of emulsifiers are possible.

While the invention has been particularly shown and described as referenced to the embodiments thereof, those skilled in the art will understand that the foregoing and other changes in form and detail may be made therein without departing from the spirit and scope of the invention.

What is claimed is:

1. A method for preparing clear plant extract emulsions, comprising:
mixing sugar with water;
adding a bitter blocker to the mixed sugar and water forming an aqueous phase;
combining the aqueous phase with an oil phase comprising a plant extract and sucrose ester;
mixing the combined aqueous phase and oil phase under heat;
performing a two-part homogenization of the combined aqueous and oil phases resulting in a clear emulsion concentrate with a low turbidity.

2. A method according to claim 1, wherein the turbidity of the clear emulsion concentrate is 10 NPU or below.

3. A method according to claim 1, further comprising:
adding the clear emulsion concentrate to a beverage, food product, medical product, or cosmetic product.

4. A method according to claim 1, further comprising:
adding a bitter blocker to one of the aqueous phase or the oil phase.

5. A method according to claim 1, further comprising:
adding one or more of a preservatives, acidifiers, or flavor modifier to the aqueous phase.

6. A method according to claim 1, further comprising:
adding an emulsifier to the oil phase.

7. A method according to claim 6, wherein the emulsifier comprises lecithin.

8. A method according to claim 7, wherein the lecithin is extracted from a plant, animal, or algae.

9. A method according to claim 1, wherein the homogenization comprises two or more passes through the two-part homogenization.

10. A method according to claim 1, further comprising:
adding a phospholipid to the oil phase.

11. A method according to claim 1, wherein a purity of the plant extract is at least 70%.

12. A method according to claim 11, further comprising:
obtaining a sample of the oil phase; and
performing an assay of the sample to determine whether the purity of the plant extract is at least 70%.

13. A clear plant extract emulsion, comprising:
CBD isolate;
water;
sugar;
a bitter blocker;
sucrose ester; and
a diluent oil combined with the CBD isolate, sucrose ester, water, sugar, and bitter blocker as an emulsion concentrate.

14. A clear plant extract emulsion according to claim 13, wherein a turbidity of the emulsion concentrate is 10 NPU or below.

15. A clear plant extract emulsion according to claim 13, further comprising:
one of a beverage, food product, medical product, or cosmetic product mixed with the emulsion concentrate.

16. A clear plant extract emulsion according to claim 13, further comprising:
one or more of a preservative, acidifier, or flavor modifier added to the emulsion concentrate.

17. A clear plant extract emulsion according to claim 13, further comprising:
an emulsifier combined with the sucrose ester.

18. A clear plant extract emulsion according to claim 17, wherein the emulsifier comprises lecithin.

19. A clear plant extract emulsion according to claim 18, wherein the lecithin is extracted from a plant, animal, or algae.

20. A clear plant extract emulsion according to claim 13, wherein a purity of the plant extract is at least 70%.
